(19) United States
(12) Patent Application Publication
(10) Pub. No.: US 2005/0273213 A1
(43) Pub. Date: Dec. 8, 2005

(54) An Improved Interface for Vehicle Users

(76) Inventor: Riley Little, Chesterfield, VA (US)

Correspondence Address: Riley Little, 5132 Hartsdale Road, Chesterfield, VA, 23832, US

(21) Appl. No.: 10/908,981

(22) Filed: Jun. 3, 2005

Related U.S. Application Data
(60) Provisional application No. 60/576,883, filed on Jun. 3, 2004.

(51) Int. Cl. G06F 17/00

(52) U.S. Cl. 701/1; 701/36

(57) ABSTRACT

The present invention provides an interface system and methods for conveying stored electronic or digital information about a vehicle. The interface enables a user to access graphic and/or audiovisual presentation about a vehicle, as well as optionally providing means for receiving updated information. The interface may occur within a vehicle, through a computer, or through a wireless handheld device.

### CROSS REFERENCE TO RELATED APPLICATIONS

This application claims the benefit of previously filed U.S. Provisional Application No. 60/575,883 filed Jun. 3, 2004 under 35 U.S.C. §119(e).

### BACKGROUND

For most motor vehicles, including automobiles, trucks, motorcycles, and the like, a written user's manual is provided by the manufacturer to provide information and resources regarding the vehicle to its users. This written user's manual or book is generally stored in a compartment within the vehicle for access during an emergency, or for assistance in repairs or maintenance. It is customary for most vehicle owners, prospective owners, or users when questions arise to refer to this manual by utilizing a table of contents or index of subjects addressed in the manual and then turning to that section and reading the manual. The present invention improves the interface between a vehicle and its users by providing electronically accessible text, audio, and/or video support and information about a vehicle; and furthermore, improves access to vehicle updates or recall information through a system that is capable of receiving additional information.

### BRIEF SUMMARY OF THE INVENTION

The embodiments provided herein improve access to information for vehicle users about a vehicle through the implementation of assemblies and methods that surpass traditional written manuals in ease of use and interaction. These embodiments encompass means for conveying information about vehicles by presenting information in a format that is accessible visually via electronic text, and/or an audio presentation, and/or a video presentation mechanism.

Information may be accessed through a storage device, such as a CD-ROM or other media. This storage device facilitates access to electronic or computer-based text, audio information, and/or video information through an electronic or digital interface. These embodiments may present information about a vehicle that can be accessed or stored within the vehicle or in any other convenient location. The interface for storing and accessing information may also be achieved by programming data in a computer chip or similar device that may be placed within the electrical control circuitry of the vehicle, or a device that is accessible by other instruments. Mechanisms for updates about the vehicle or vehicle recalls may be provided through satellite uplinkages from a vehicle, and/or updates may be downloaded to a storage device.

### DETAILED DESCRIPTION OF EMBODIMENTS

In an embodiment, a storage device for accessing the presentation of electronic text, audio data, and/or video data, such as a CD-ROM, is provided or is accessible to facilitate the presentation of information about a vehicle. Additionally, mechanisms for acquiring updates or new information about the vehicle and its equipment may be utilized. In an embodiment, information about a vehicle would be transferred to a storage device that a user would interface through connection of the storage device to a means for presentation, such as a computer.

As presented in embodiments herein, a storage device may encompass, but is not limited to, means for storing electronic or digital information such as a CD-ROM, computer disc, circuit, or chip. In another embodiment the storage device may be a computer, a networked computer or circuit, or a server.

As presented in embodiments herein, a means for accessing data about a vehicle may include the transmission of data directly through connection of a media source, such as a CD-ROM to a personal computer, laptop, or handheld device. Other means for accessing data include transmission between devices, such as through computer networks or over the internet. It is also contemplated that wireless transmission from a storage device or location may serve to provide access to stored information from these devices, either directly through airwaves or indirectly through the assistance of a satellite.

As presented in embodiments herein, a means for presenting data about a vehicle may include the visual and audio components of a computer, laptop, or handheld device, that are capable of displaying text and/or graphics and/or audiovisual material. Additional means for presenting data include compact disc players, portable electronic devices, and digital video players that are freestanding, as well as those hardwired into a vehicle. It is implicit in the use of computers and audiovisual devices that an electronic or programming conversion transpire in which the data is converted into a format that is appreciable visually and/or auditorally. Therein, upon connection of a storage device with a means for accessing the data, such as a computer, the means for presentation may also be a computer that utilizes software to translate the data into an interpretable format. The software may be a program such as Microsoft Word® or Adobe Acrobat Reader®.

In another embodiment, the storage device may encompass a chip or electronic circuit encoding data that is placed in a vehicle, which interacts intermittently or at all times with the vehicle's operational and diagnostic functions. The user is thereby able to access stored or new information about the vehicle through the vehicle's audio and/or video capabilities. Updated information could be acquired by spontaneous transmission through a wireless satellite-type connection to the vehicle, or by user-initiated downloads to the vehicle's storage system for the electronic or digital information.

In an embodiment, the information on a storage device could encompass digitally stored text, audio and/or video information and instructions for routine use and repair of the vehicle and its equipment, safety information, limitations and maintenance requirements of the vehicle, emergency procedures for vehicle repair or basic first aid for injured persons, warranty information, locations of repair centers, and demonstrations of proper use and repair of the vehicle. The storage device may facilitate the interactions between an owner and vehicle when a user is within the vehicle, or outside the vehicle through the convenience of a personal computer, CD or DVD player, or handheld wireless organizational and telephonic devices.

In another embodiment of the present invention, the storage device may be compiled and distributed independently and outside the scope of provision by an automobile manufacturer. The stored information may be compiled from the user's manual and/or any other available information, and then stored and manufactured for commercial sale by a wholesale or retail merchant. Further, the storage device may be located on a personal computer or server that is accessed by individual or multiple users; or it may be accessed through the internet or world wide web, such that users may interact with the information at the discretion of a manager or web site owner. Therein customers may pay to download, print, or reduce information to personal storage devices at their own discretion.

The reduction of information to a storage device is well-known in the art of computerized programming and data storage, and the present embodiments contemplate the use of any or all of these methods of data processing, storage, retrieval, and presentation. Further, the present embodiments are not limited to presently available or conceived means for data storage, retrieval, and presentation but also encompass any potential method for practicing the embodiments disclosed herein. For example, a user's manual or written guidelines may be entered into a computer-based format such as a word-processing program. Subsequently, this information may be saved and stored on the computer or to a separate storage device, such as a disc. Therein, the information on the storage device could then be copied to provide an interactive format through which a user could interface with the information electronically. In an embodiment, the implementation of programming features known to those skilled in the art would enable a user to select particular areas of material to read, print, or even link to computer-based internet sites that could provide even more detailed information.

In another embodiment, the data about a particular vehicle could be transcribed into a digital or electronic format by manual entry or scanning of text about the vehicle using a scanner connected to a computer, with data then saved to a computer chip in an electronic or digital format. This process, as well as other similar methods, is well known to those skilled in the art of electronic or digital data storage. Additionally, this information would be accessible to electronic devices compatible with the chip and able to extract its saved information. Therein, in such an embodiment, the information stored on the chip could be provided to a user by virtue of known methods for accessing and translating stored information ny devices capable of presenting it—such as digital audiovisual equipment.

As discussed in the context of the embodiments presented herein, a motor vehicle may include, but is not limited to, automobiles, trucks, buses, vans, motorcycles, recreational vehicles, boats, tractors, construction equipment, and other motorized sources of travel or mechanized labor. Additional embodiments are also contemplated in which information about non-motorized vehicles can be electronically stored and accessed, such as hot air balloons, air gliders, canoes, or bicycles.

This invention is susceptible to considerable variation in its practice. Accordingly, this invention is not limited to the specific exemplifications set forth hereinabove.

The patentee does not intend to dedicate any disclosed embodiments to the public, and to the extent any disclosed modifications or alterations may not literally fall within the scope of the claims, they are considered to be part of the invention under the doctrine of equivalents.

1. An assembly for conveying information about a vehicle comprising:
a storage device storing data about a vehicle in an electronic or digital format; and
means for presenting stored data in a manner understandable to a user.

2. The assembly of claim 1, wherein the stored electronic or digital data is presented to a user in the form of text.

3. The assembly of claim 1, wherein the stored electronic or digital data is presented to a user in the form of graphics.

4. The assembly of claim 1, wherein the stored electronic or digital data is presented auditorally.

5. The assembly of claim 1, wherein the stored electronic or digital data is presented in an audiovisual video format.

6. The assembly of claim 1, further comprising means for accessing the storage device.

7. The assembly of claim 6, wherein the means for accessing the storage device is a computer able to translate stored electronic or digital data, the means for presenting data to the user is a computer's display, and the storage device is a computer disc.

8. The assembly of claim 6, wherein the means for accessing the storage device is a networked device.

9. The assembly of claim 1, wherein the storage device is in connection with the internet and accessed by an apparatus connected to the internet.

10. The assembly of claim 1, wherein the storage device is connected to means for generating a wireless signal, and wherein the means for presenting data to the user is a wireless device that received wireless data that had been stored on the storage device.

11. The assembly of claim 1, wherein the means for presenting the data to a user is a compact disc player.

12. The assembly of claim 1, wherein the means for presenting the data is a digital video disc machine.

13. The assembly of claim 1, wherein the means for presenting data is a computer comprising software to translate stored electronic or digital data into visual text or a graphic format and a display for presenting the visual text or graphic format.

14. The assembly of claim 1, wherein the means for presenting data is a device integrated within a vehicle.

15. The assembly of claim 1, wherein the means for presenting data is a device having at least one capability selected from the group consisting of audio emitting capability, visual display capability, audiovisual capability, and digital transmission capability.

16. A vehicle having assembly for providing data about the vehicle to a user comprising:
a vehicle;
at least one electronic means for receiving, storing and transmitting electronic or digital information about the vehicle; and
connecting means enabling the electronic means to connect and transfer the electronic or digital information to an audio or visual display system integrated within the vehicle.

17. The vehicle of claim 16, wherein the electronic means further comprises means for receiving additional information.

18. The vehicle of claim 17, further comprising means for alerting a user when additional information is received.

19. A method for providing access to information about a vehicle comprising:
compiling electronic or digital information about a vehicle;
storing the electronic or digital information about the vehicle in a storage system; and
providing the stored information to a device capable of translating the data into information understandable to a user.
